(19) United States
(12) Patent Application Publication
(10) Pub. No.: US 2026/0337109 A1
(43) Pub. Date: Oct. 29, 2026

(54) MAGNESIA-ALUMINA CASTABLE AND REFRACTORY BLOCK

(71) Applicant: TOKYO YOGYO KABUSHIKI KAISHA, Tokyo (JP)

(72) Inventors: Shogo Yamada, Tajimi-shi (JP); Kenji Yanagi, Tajimi-shi (JP)

(73) Assignee: TOKYO YOGYO KABUSHIKI KAISHA, Tokyo (JP)

(21) Appl. No.: 19/106,421

(22) PCT Filed: Oct. 25, 2022
(86) PCT No.: PCT/JP2022/039596

§ 371 Date: Feb. 25, 2025

(30) Foreign Application Priority Data
Aug. 30, 2022 (JP) 2022-136386

(51) Int. Cl. C04B 35/03

(52) U.S. Cl. CPC C04B 35/03; C04B 2235/3206; C04B 2235/3217; C04B 2235/3418; C04B 2235/5427; C04B 2235/5436

(57) ABSTRACT

The magnesia-alumina castable can exhibit both corrosion resistance and thermal spalling resistance with good balance. The magnesia-alumina castable of the present invention contains 60 to 90 mass % of magnesia, 10 to 35 mass % of alumina, and 5 mass % or less of silica. The present application also provides a refractory block.

### TECHNICAL FIELD

The present invention relates to a magnesia-alumina castable and a refractory block.

### BACKGROUND ART

Castables and refractory blocks are used for ladles, snorkels, lance pipes, tundishes, gutter linings, and linings of melting furnaces and incinerators, etc.. The castable is a refractory material which is subjected to casting molding, pressure feeding molding, spraying molding, and the like. The refractory block is obtained by adding water to the castable, and curing and hardening the mixture, followed by drying.

Most of the current castables are alumina-rich alumina-magnesia castables. Patent Literature 1 discloses an alumina-magnesia castable containing 65 to 85 mass % of alumina, 5 to 25 mass % of magnesia, and 30 mass % or less of silica. Since alumina and magnesia are contained, alumina reacts with magnesia during firing, so that spinel is formed, leading to densification of the structure. For this reason, a refractory block having excellent corrosion resistance is obtained.

### CITATION LIST

### Patent Literature

Patent Literature 1: JP H2-208260 A

### SUMMARY OF INVENTION

### Technical Problem

In recent years, the grade of steel has been becoming higher, and a castable capable of further improving corrosion resistance has been desired. It may be recommendable to increase the amount of magnesia in the castable because magnesia has excellent corrosion resistance. However, if the amount of magnesia in the castable is increased, the thermal expansion coefficient of the refractory block increases, so that the cracks are easily generated in the refractory block, and thermal spalling resistance deteriorates.

The present invention has been made to solve the problems described above, and an object of the present invention is to provide a magnesia-alumina castable and a refractory block which can exhibit both corrosion resistance and thermal spalling resistance with good balance.

### Solution to Problem

For solving the problems described above, an aspect of the present invention provides a magnesia-alumina castable containing 60 to 90 mass % of magnesia, 10 to 35 mass % of alumina, and 5 mass % or less of silica.

Another aspect of the present invention provides a refractory block containing 60 to 90 mass % of magnesia, 10 to 35 mass % of alumina, and 5 mass % or less of silica.

A preferred aspect of the present invention is characterized in that as at least a part of the alumina, 5 to 30 mass % of coarse alumina particles having a particle diameter of 3 to 8 mm and 10 mass or less of ultrafine alumina powder having a particle diameter of 10 μm or less are contained.

### Advantageous Effects of Invention

According to the present invention, the magnesia-alumina castable is rich in magnesia, and therefore capable of significantly improving corrosion resistance. In addition, the silica undergoes glass melting, softens, and absorbs expansion during firing, so that deterioration of thermal spalling resistance can be suppressed. Therefore, both corrosion resistance and thermal spalling resistance can be exhibited with good balance.

If the amount of formation of spinel becomes excessive, expansion occurs, so that the structure degrades, leading to deterioration of erosion resistance (one of indices of corrosion resistance). According to a preferred aspect of the present invention, 10 mass % or less of ultrafine alumina powder with a particle diameter of 10 μm or less, which easily forms spinel, and 5 to 30 mass % or less of coarse alumina particles with a particle diameter of 3 to 8 mm, which hardly form spinel and are likely to remain as corundum (alumina), are contained. The amount of formation of spinel can thus be controlled to be at an optimum value, so that it is possible to further improve the erosion resistance.

### BRIEF DESCRIPTION OF DRAWINGS

FIG. 1 is a diagram illustrating a rotating drum test.

FIG. 2 is a diagram illustrating a thermal spalling resistance test.

### DESCRIPTION OF EMBODIMENT

Hereinafter, a magnesia-alumina castable and a refractory block according to an embodiment of the present invention will be described. However, the magnesia-alumina castable and the refractory block of the present invention can be concretized in various forms, and are not limited to the embodiment described in the present specification. The present embodiment is provided with the intention of making the disclosure in the specification complete to ensure that those skilled in the art can fully understand the invention.

The magnesia-alumina castable according to the present embodiment is a magnesia-rich magnesia-alumina castable. Specifically, the alumina-magnesia castable according to the present embodiment contains 60 to 90 mass % of magnesia, 10 to 35 mass % of alumina, and 5 mass % or less of silica.

Magnesia is a refractory material. Magnesia is blended in an amount of 60 to 90 mass per 100 mass % of the castable. In the present embodiment, the purpose of setting the amount of magnesia as described above is to significantly improve corrosion resistance. If the amount of magnesia is less than 60 mass %, erosion resistance (one of indices of corrosion resistance) against molten steel and slag deteriorates. If the amount of magnesia exceeds 90 mass %, the amount of alumina becomes relatively small, and spinel is hardly formed, so that slag permeation resistance (one of indices of corrosion resistance) deteriorates. The optimum amount of magnesia is 60 to 90 mass %, preferably 70 to 80 mass %.

The particle size of magnesia is not particularly limited, and it is desirable that magnesia include, for example, coarse particles, medium particles, and fine powder. The use of the fine powder increases the surface area of magnesia, and facilitates formation of spinel.

Alumina is a refractory material. Alumina is blended in an amount of 10 to 35 mass % per 100 mass % of the castable. In the present embodiment, the purpose of setting the amount of alumina as described above is to significantly improve corrosion resistance by relatively increasing the amount of magnesia, and to improve thermal spalling resistance. If the amount of alumina is less than 10 mass %, the amount of formation of spinel decreases, leading to deterioration of slag permeation resistance. If the amount of alumina exceeds 35 mass %, the amount of magnesia relatively decreases, leading to deterioration of erosion resistance. The optimum amount of alumina is 10 to 35 mass %, preferably 20 to 30 mass %.

For the particle size of alumina, it is desirable that coarse alumina particles having a particle diameter of 3 to 8 mm, preferably coarse alumina particles having a particle diameter of 3 to 5 mm, be blended in an amount of 5 to 30 mass % per 100 mass % of the castable, and ultrafine alumina powder having a particle diameter of 10 μm or less be blended in an amount of 10 mass % or less per 100 mass % of the castable. If the amount of formation of spinel becomes excessive, expansion occurs, so that the structure degrades, leading to deterioration of erosion resistance. In the present embodiment, the purpose of setting coarse alumina particles and the ultrafine alumina powder as described above is to control the amount of formation of spinel at an optimum value, so that erosion resistance is further improved. By using ultrafine alumina powder with a particle diameter of 10 μm or less, which easily forms spinel, and coarse alumina particles with a particle diameter of 3 to 8 mm, which hardly form spinel and are likely to remain as corundum (alumina), the amount of formation of spinel can be controlled to be at an optimum value.

The particle diameter other than that of the ultrafine powder is based on the nominal aperture of JIS 28801-1:2019. The particle diameter of the ultrafine powder is an average particle size (D50). For the ultrafine alumina powder of 10 μm or less, for example, calcined alumina CL370C or A300FL manufactured by Almatis Company can be used. The average particle size (D50) thereof is 2.5 μm.

Silica is blended in an amount of 5 mass % or less per 100 mass % of the castable. In the present embodiment, the purpose of setting the amount of silica to 5 mass % or less is to suppress deterioration of thermal spalling resistance. If the amount of magnesia is increased, the thermal expansion coefficient of the refractory block increases. Therefore, cracks are easily generated in the refractory block, and the thermal spalling resistance deteriorates. When silica is blended, the silica undergoes glass melting, softens, and absorbs expansion during firing, so that deterioration of thermal spalling resistance can be suppressed. If the amount of silica exceeds 5 mass %, the amount of glass melting becomes excessively large, and corrosion resistance deteriorates.

It is desirable to use, as the silica, 3 mass % or less of amorphous ultrafine silica powder having a particle diameter of 5 μm or less. When the amorphous ultrafine silica powder is used, the raw material improves in fluidity, and can be subjected to molding with a low water content. The particle diameter of the ultrafine powder is an average particle size (D50). The amorphous ultrafine silica powder having a particle diameter of 5 μm or less is commercially available as Silica Flower, Microsilica (registered trademark) or less. The average particle size (D50) thereof is 5 μm or the like.

It is desirable that cement be blended in an amount of 10 mass % or less with respect to the sum of the amount of magnesia and the amount of alumina. In the present embodiment, the purpose of setting the blending amount of cement as described above is to improve the strength of the refractory block. If the amount of cement exceeds 10 mass %, a low-melting product is formed, and corrosion resistance deteriorates. The type of cement is not particularly limited. For example, alumina cement can be used.

If necessary, a dispersant may be added for obtaining a homogeneous refractory block from the castable. As the dispersant, for example, one or more selected from sodium tripolyphosphate, sodium hexametaphosphate, acidic sodium hexametaphosphate, sodium sulfonate, sodium naphthalenesulfonate, sodium lignin sulfonate, sodium ultrapolyphosphate, polyacrylic acid salts, polycarboxylic acid, polycarboxylic acid salts, and the like can be used.

If necessary, a hardening regulator can be added for imparting an appropriate working life to the castable. As the hardening regulator, for example, one or more selected from boric acid, oxalic acid, citric acid, gluconic acid, ammonium borate, sodium ultrapolyphosphate, lithium carbonate, sodium carbonate, sodium borate, sodium citrate, tartaric acid salts, and the like can be used.

As a method for molding the castable, a well known molding method such as casting molding, pressure feeding molding or spraying molding can be used. An example of the casting molding will be described. Water is added to a magnesia-alumina castable and the mixture is kneaded until the flow value becomes constant. Subsequently, the kneaded product is cast into a predetermined mold on a vibrating table. The product is cured, for example, at room temperature for 24 hours, then demolded, and dried at 110 °C for 24 hours.

### EXAMPLES

Table 1 shows the formulations of castables of Comparative Example 1, Examples 1 to 7 and Comparative Example 2, the physical properties of refractory blocks produced using the castables, and dried at 110 °C for 24 hours, and the physical properties of the refractory blocks fired at 1,500 °C for 3 hours.

TABLE 1

| | | | | Compar- | | | | |
|---|---|---|---|---|---|---|---|---|
| | | | | ative | | | | |
| | | | | Exam- | Exam- | Exam- | Exam- | Exam- |
| | | | | ple 1 | ple 1 | ple 2 | ple 3 | ple 4 |
| Formulation | Magnesia | | | 5 | 70 | 75 | 80 | 85 |
| (mass %) | Alumina | Coarse | 8 to 3 mm | ◯ | — | — | — | — |
| | | particle | | | | | | |
| | | Medium | 3 to 1 mm | ◯ | ◯ (25) | ◯ (20) | ◯ (15) | ◯ (10) |
| | | particle | | | | | | |
| | | Fine powder | 1 to 10 μm | ◯ | — | — | — | — |
| | | Ultrafine | 10 μm or | ◯ | ◯ (5) | ◯ (5) | ◯ (5) | ◯ (5) |
| | | powder | less | | | | | |
| | | Total | | 87.5 | 30 | 25 | 20 | 15 |
| | Amorphous silica | | | 0.3 | 0.5 | 0.5 | 0.5 | 0.5 |
| | Cement | | | 7.5 (with | 3 (with | 3 (with | 3 (with | 3 (with |
| | | | | respect | respect | respect | respect | respect |
| | | | | to sum of | to sum of | to sum of | to sum of | to sum of |
| | | | | magnesia | magnesia | magnesia | magnesia | magnesia |
| | | | | and | and | and | and | and |
| | | | | alumina) | alumina) | alumina) | alumina) | alumina) |
| Chemical | | MgO | | 5 | 65 | 70 | 75 | 80 |
| composition | | Al2O3 | | 93 | 32 | 27 | 22 | 17 |
| (mass %) | | SiO2 | | 1 | 1 | 1 | 1 | 1 |
| Physical | 110 °C × | Porosity/% | | 16.4 | 16.5 | 16.1 | 16.2 | 16 |
| property | 24 h | Bulk specific | | 3.09 | 2.91 | 2.93 | 2.95 | 2.97 |
| | | gravity | | | | | | |
| | | Compressive | | 14 | 20 | 23 | 20 | 18 |
| | | strength/MPa | | | | | | |
| | 1500 °C × | Porosity/% | | 20.5 | 16.6 | 18.5 | 18.7 | 20.2 |
| | 3 h | Bulk specific | | 3.01 | 2.94 | 2.87 | 2.88 | 2.82 |
| | | gravity | | | | | | |
| | | Compressive | | 58 | 56 | 60 | 54 | 39 |
| | | strength/MPa | | | | | | |
| | 1500 °C × | Corrosion | Erosion | X | ◯ | ◯ | ◯ | ◯ |
| | 3 h | resistance | resistance*1 | | | | | |
| | | | Slag | ⊚ | ⊚ | ⊚ | ◯ | ◯ |
| | | | permeation | | | | | |
| | | | resistance*2 | | | | | |

| | | | | | |
|---|---|---|---|---|---|
| Thermal spalling | ◯ | ◯ | ◯ | ◯ | ◯ |
| resistance*3 | | | | | |
| Amount of | + | +++ | +++ | +++ | ++ |
| formation | | | | | |
| of spinel % | | | | | |
| Amount of | +++ | + | + | + | + |
| formation | | | | | |
| of corundum % | | | | | |

| | | | | | | | Compar- |
|---|---|---|---|---|---|---|---|
| | | | | | | | ative |
| | | | | Exam- | Exam- | Exam- | Exam- |
| | | | | ple 5 | ple 6 | ple 7 | ple 2 |
| Formulation | Magnesia | | | 90 | 75 | 75 | 95 |
| (mass %) | Alumina | Coarse | 8 to 3 mm | — | ◯ (20) | — | — |
| | | particle | | | | | |
| | | Medium | 3 to 1 mm | ◯ (5) | — | ◯ (20) | — |
| | | particle | | | | | |
| | | Fine powder | 1 to 10 μm | — | — | — | — |
| | | Ultrafine | 10 μm or | ◯ (5) | ◯ (5) | ◯ (5) | — |
| | | powder | less | | | | |

| | | Total | 10 | 25 | 25 | — |
|---|---|---|---|---|---|---|
| | Amorphous silica | | 0.5 | 0.5 | 0.5 | 0.5 |
| | Cement | | 3 (with | 3 (with | 3 (with | — |
| | | | respect | respect | respect | |
| | | | to sum of | to sum of | to sum of | |
| | | | magnesia | magnesia | magnesia | |
| | | | and | and | and | |
| | | | alumina) | alumina) | alumina) | |
| Chemical | | MgO | 85 | 70 | 70 | 98 |
| composition | | Al2O3 | 12 | 27 | 28 | — |
| (mass %) | | SiO2 | 1 | 1 | 1 | 1 |
| Physical | 110 °C × | Porosity/% | 16.5 | 17.1 | 16.1 | 17.6 |
| property | 24 h | Bulk specific | 2.97 | 2.91 | 2.95 | 2.91 |
| | | gravity | | | | |
| | | Compressive | 18 | 27 | 25 | 17 |
| | | strength/MPa | | | | |
| | 1500 °C × | Porosity/% | 22.3 | 17.5 | 17.2 | 11.2 |
| | 3 h | Bulk specific | 2.75 | 2.94 | 2.95 | 2.95 |
| | | gravity | | | | |
| | | Compressive | 29 | 71 | 79 | 62 |
| | | strength/MPa | | | | |

| | | | | | | |
|---|---|---|---|---|---|---|
| 1500 °C × | Corrosion | Erosion | ◯ | ⊚ | ⊚ | ⊚ |
| 3 h | resistance | resistance*1 | | | | |
| | | Slag | ◯ | ⊚ | ⊚ | X |
| | | permeation | | | | |
| | | resistance*2 | | | | |

| | | | | |
|---|---|---|---|---|
| Thermal spalling | ◯ | ◯ | ◯ | ◯ |
| resistance*3 | | | | |
| Amount of | + | + | ++ | − |
| formation | | | | |
| of spinel % | | | | |
| Amount of | + | +++ | + | − |
| formation | | | | |
| of corundum % | | | | |

*1Amount of erosion 10 mm or less: ⊚, 10 to 30 mm: ◯, 30 mm or more: X
*2Amount of permeation 2 mm or less: ⊚, 2 to 10 mm: ◯, 10 mm or more: X
*3Number of cycles until falling ◯: 5 or more

Comparative Example 1 is an alumina-rich alumina-magnesia castable. Examples 1 to 7 are magnesia-rich magnesia-alumina castables. In Examples 1 to 7, the amount of magnesia and the amount of alumina are changed. Comparative Example 2 is a castable which includes only magnesia as a refractory material, and is free of alumina.

First, the chemical composition of the refractory block dried at 110 °C for 24 hours was measured using a fluorescent X-ray analysis method. The fluorescent X-ray analysis method of the composition of a refractory is provided in JIS R 2216:2005. As shown in Table 1, the chemical composition of the refractory block was substantially identical to the formulated composition of the castable.

Next, the porosity, bulk specific gravity and compressive strength of the refractory block dried at 110 °C for 24 hours were measured. A method for measuring the porosity and the bulk specific gravity of a refractory is provided in JIS R 2205:1992. A test method for the compressive strength of a refractory is provided in JIS R 2206:2007. In the refractory block dried at 110 °C for 24 hours, an increase in the amount of magnesia made little change in porosity, bulk specific gravity and compressive strength.

Next, the porosity, bulk specific gravity and compressive strength of the refractory block fired at 1500 °C for 3 hours were measured. In the refractory block fired at 1500 °C for 3 hours, there was a tendency that the porosity increased, the bulk specific gravity decreased and the compressive strength decreased as the amount of magnesia increased. This is thought to be because the thermal expansion coefficient of the refractory block rises as the amount of magnesia increases.

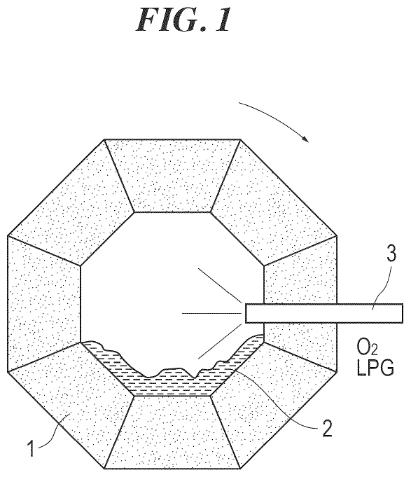

Next, the corrosion resistance (i.e., erosion resistance and slag permeation resistance) of the refractory block was evaluated by a rotating drum test. As shown in FIG. 1, refractory block samples 1 were combined in a cylindrical shape, synthetic slag 2 (C/S=2.0) was added, and heating was performed using an oxygen-propane burner 3 such that the internal temperature was maintained at 1600 to 1650 °C. The time period of the test was 10 hours, the rotation direction was constant, and the rotation speed was 8 rpm.

After the rotating drum test, the amount of erosion of the refractory block sample 1 was measured. In Table 1, the symbol “⊚” means that the amount of erosion is 10 mm or less, the symbol “∘” means that the amount of erosion is 10 to 30 mm, and the symbol “x” means that the amount of erosion is 30 mm or more.

In the alumina-rich castable of Comparative Example 1, the amount of erosion was large as shown in Table 1. However, in the magnesia-rich castables of Examples 1 to 7 and the castable with only magnesia in Comparative Example 2, the amount of erosion decreased (i.e., erosion resistance was improved) as the amount of magnesia increased.

Next, the amount of slag permeation in the refractory block sample 1 was measured. In Table 1, the symbol “⊚” means that the amount of slag permeation is 2 mm or less, the symbol “◯” means that the amount of slag permeation is 2 to 10 mm, and the symbol “x” means that the amount of slag permeation is 10 mm or more.

In Comparative Example 2, the amount of slag permeation was large. In Examples 1 to 7 as well as Comparative Example 1, the amount of slag permeation was small (i.e., the slag permeation resistance was improved). It is to be noted, as in Examples 1 to 3, 6 and 7, the erosion resistance and the slag permeation resistance were further improved by setting the amount of magnesia to 70 to 80 mass % and the amount of alumina to 20 to 30 mass. In particular, in Examples 6 and 7, ⊚ was assigned for both erosion resistance and slag permeation resistance.

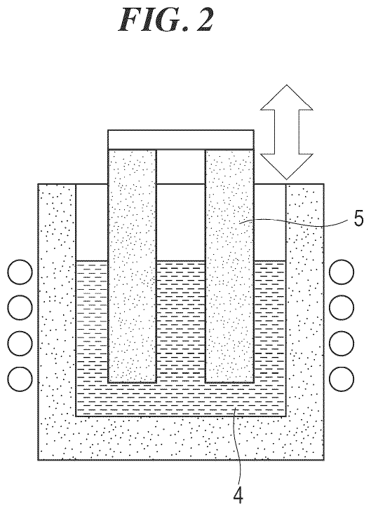

Next, a thermal spalling resistance test was conducted. Refractory block samples of 40 mm×40 mm×230 mm were prepared, and dried at 110 °C for 24 hours. As shown in FIG. 2, the refractory block sample 5 was immersed in molten metal 4 heated to 1500 to 1550 °C for 15 minutes. The sample 5 was pulled up from the molten metal 4, and then air-cooled for 60 minutes. This was defined as one cycle. The heating and the cooling were repeated until the sample 4 fell. In Table 1, the symbol “◯” means that the number of cycles until falling is 5 or more.

In Examples 1 to 7, the thermal spalling resistance deteriorated as compared to that in Comparative Example 1, but the amount of the deterioration was small (i.e., deterioration of thermal spalling resistance was suppressed). This showed that it was possible to use the magnesia-alumina castables of Examples 1 to 7 as a refractory.

Next, for analyzing the crystal structure of the refractory block, the refractory block was powdered, powder X-ray diffraction measurement was performed, and the amount of formation of spinel and the amount of formation of corundum (alumina) were measured by Rietveld analysis. In Table 1, the symbol “+” means that the amount is small, the symbol “++” means that the amount is larger than that of “+”, and the symbol “+++” means that the amount is larger than that of “++”.

The amount of formation of spinel ascended in the order of Example 6, Example 5, Example 7, Example 4, Example 3, Example 2 and Example 1. The structure can be densified by formation of spinel, but if the amount of formation of spinel becomes excessive, expansion occurs, so that the structure degrades. Excellent erosion resistance in Example 6 is considered to be related to this amount of formation of spinel. The amount of formation of spinel in Example 6 is considered to be close to an optimum value. Comparison between Example 2 and Example 6 shows that the difference is mainly a difference in alumina particle size, where the alumina medium particles form spinel at 1500 °C in Example 2, whereas coarse alumina particles remain as corundum (alumina) without forming spinel in Example 6. It is thought that by using coarse alumina particles having a particle diameter of 3 to 8 mm, an optimum amount of formation of spinel was achieved, resulting in improvement of erosion resistance.

The present specification is based on Japanese Patent Application No. 2022-136386 filed on Aug. 30, 2022. The contents thereof are incorporated herein in its entirety.

1. A magnesia-alumina castable comprising 60 to 90 mass % of magnesia, 10 to 35 mass % of alumina, and 5 mass % or less of silica.

2. The magnesia-alumina castable according to claim 1, comprising, as at least a part of the alumina, 5 to 30 mass % of coarse alumina particles having a particle diameter of 3 to 8 mm and 10 mass % or less of ultrafine alumina powder having a particle diameter of 10 μm or less.

3. The magnesia-alumina castable according to claim 1, comprising, as at least a part of the silica, 3 mass % or less of amorphous ultrafine silica powder having a particle diameter of 5 μm or less.

4. The magnesia-alumina castable according to claim 3, comprising cement in an amount of 10 mass % or less with respect to a sum of an amount of the magnesia and an amount of the alumina.

5. A refractory block comprising 60 to 90 mass % of magnesia, 10 to 35 mass % of alumina, and 5 mass % or less of silica.

6. The refractory block according to claim 5, comprising, as at least a part of the alumina, 5 to 30 mass % of coarse alumina particles having a particle diameter of 3 to 8 mm and 10 mass % or less of ultrafine alumina powder having a particle diameter of 10 μm or less.

7. The magnesia-alumina castable according to claim 2, comprising, as at least a part of the silica, 3 mass % or less of amorphous ultrafine silica powder having a particle diameter of 5 μm or less.
